(19) United States
(12) Patent Application Publication
(10) Pub. No.: US 2004/0074836 A1
(43) Pub. Date: Apr. 22, 2004

(54) Eductor circulated nut shell media filter

(76) Inventor: Robert Joseph Long, Katy, TX (US)

Correspondence Address: ROBERT J. LONG, 19927 EDENSBOROUGH, KATY, TX, 77449, US

(21) Appl. No.: 10/277,276

(22) Filed: Oct. 21, 2002

(51) Int. Cl. B01D 27/00

(52) U.S. Cl. 210/435

(57) ABSTRACT

This patent application covers a nutshell media filter with an external, horizontally mounted media retention screen, a concentric flow inlet distributor, a vessel false bottom, the use of an eductor to circulate filter media, use of a jackshaft/pillow block bearing to drive the circulation pump, and a plug flow displacement step in the media cleaning cycle.

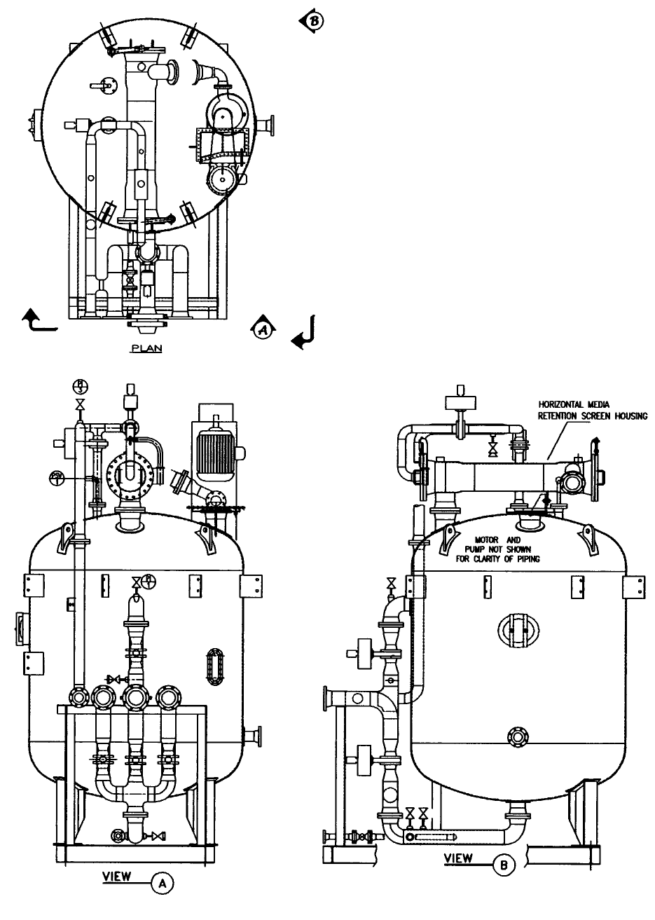

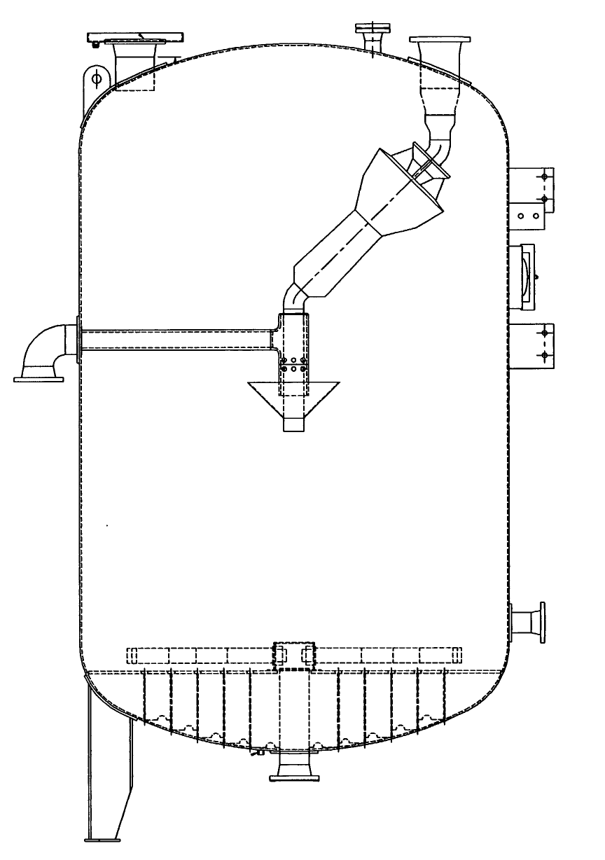

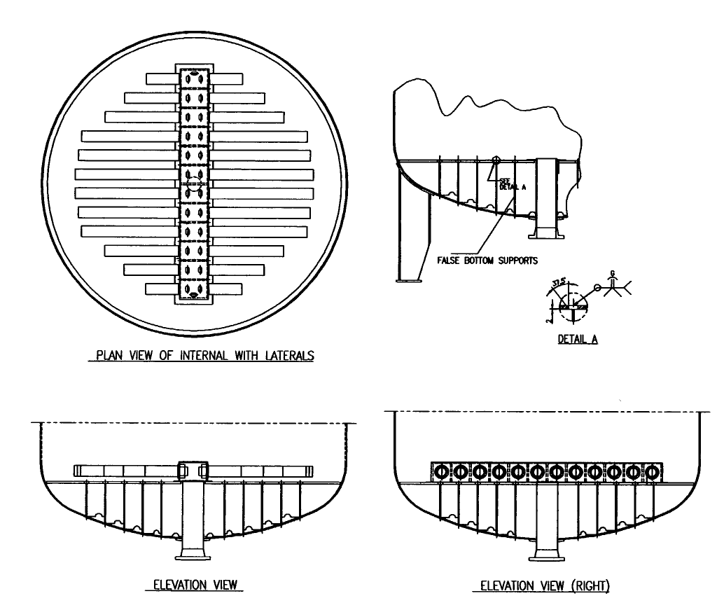

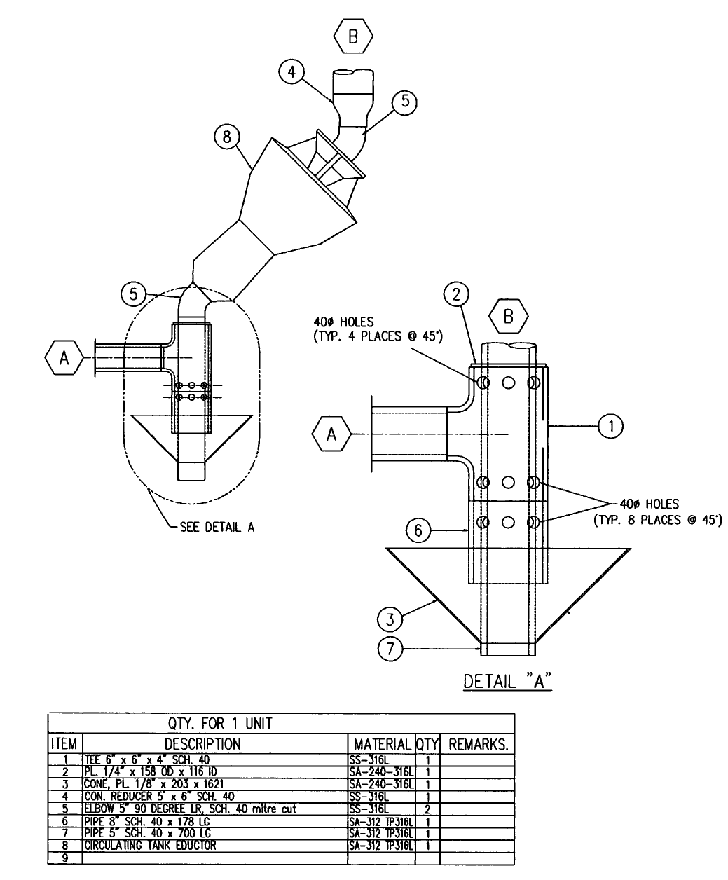

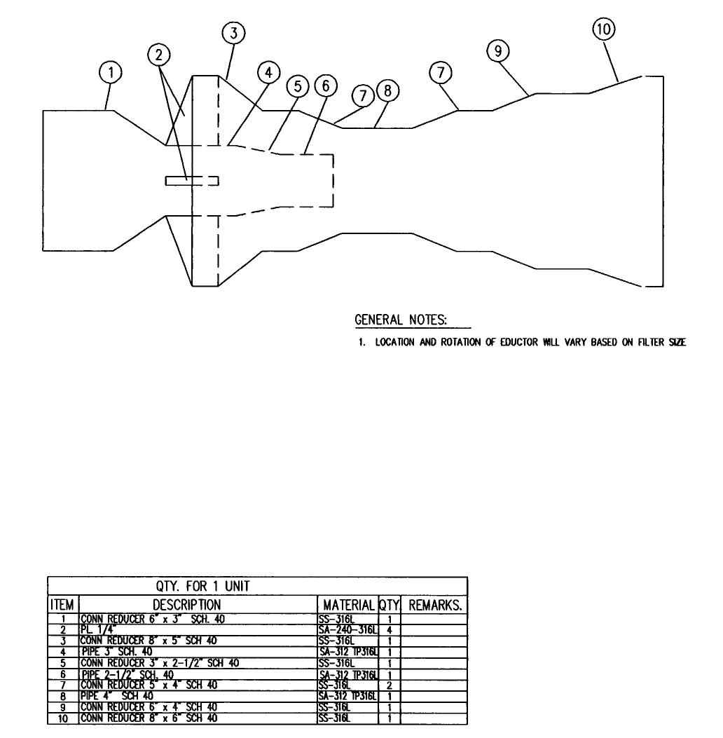

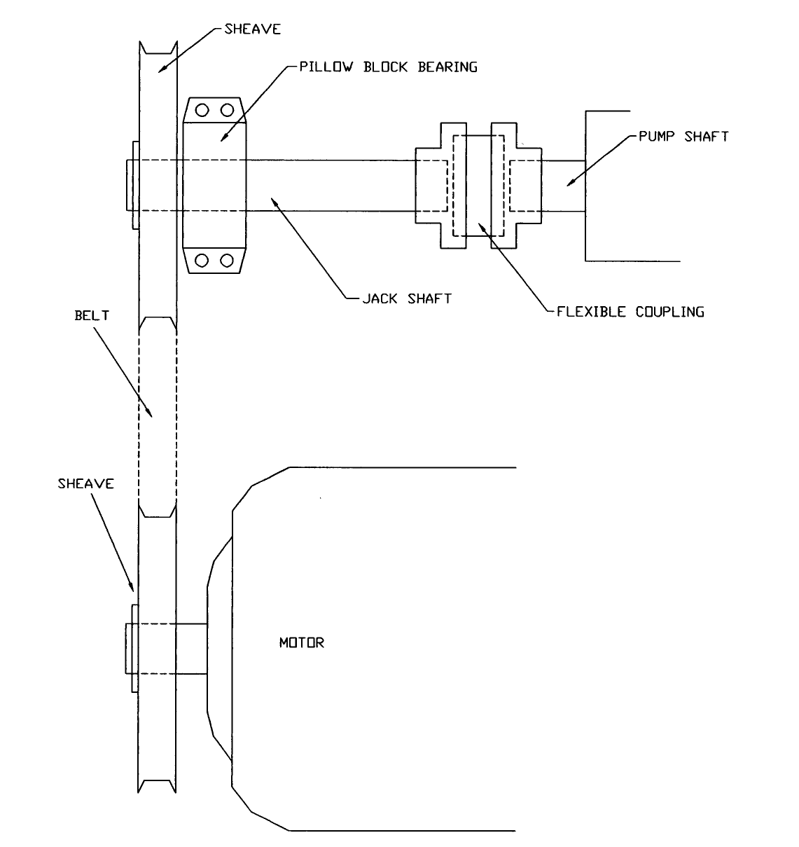

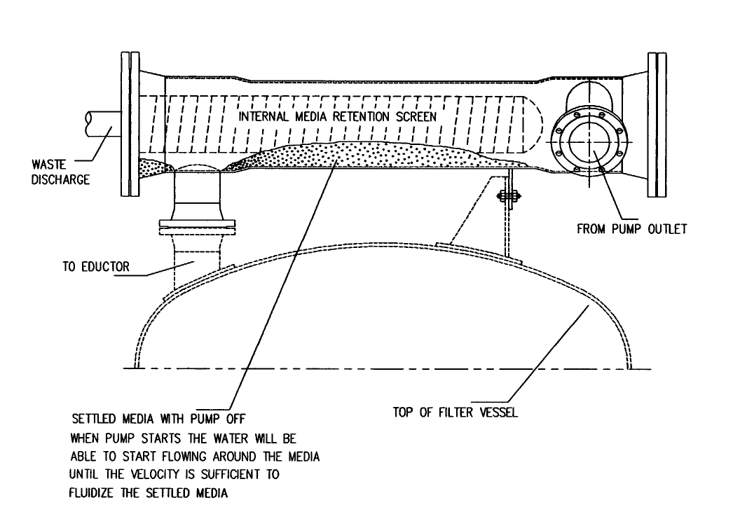

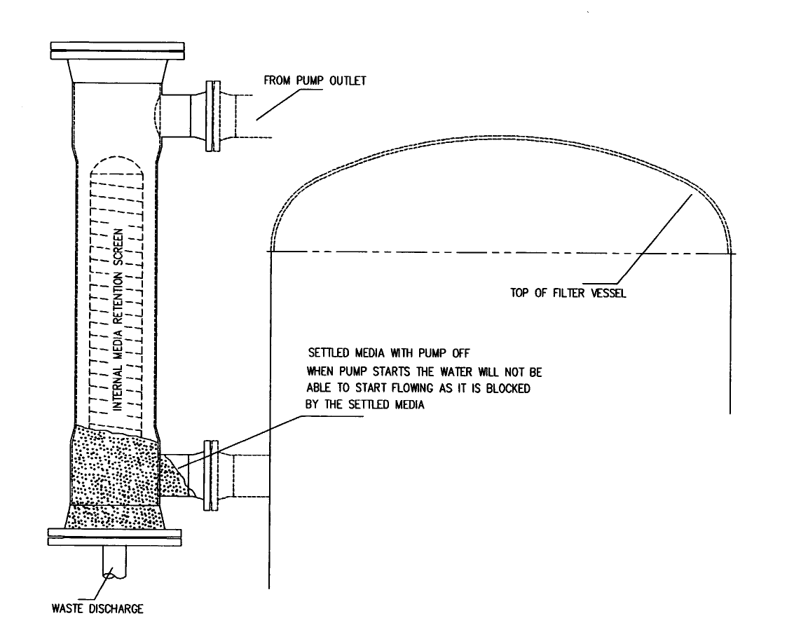

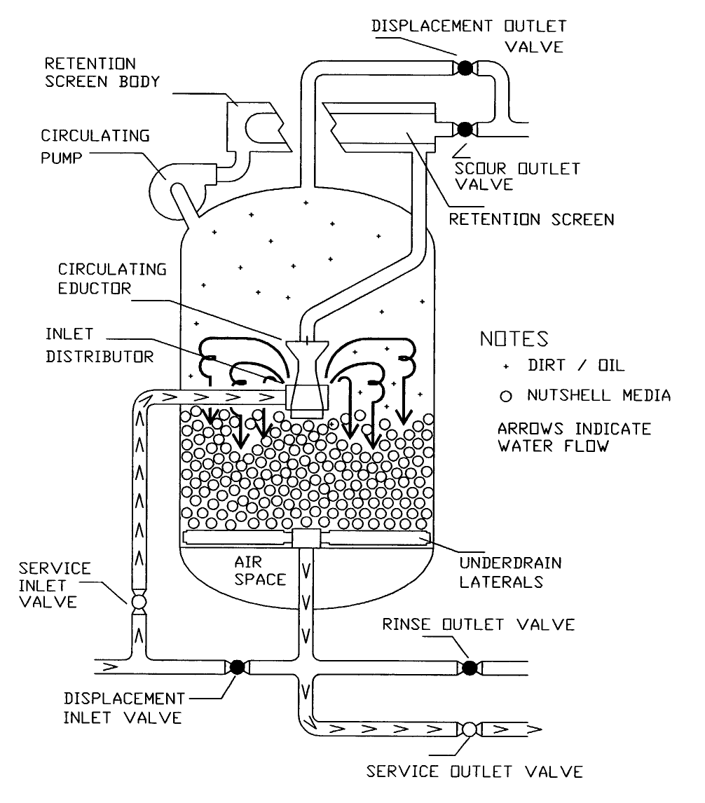

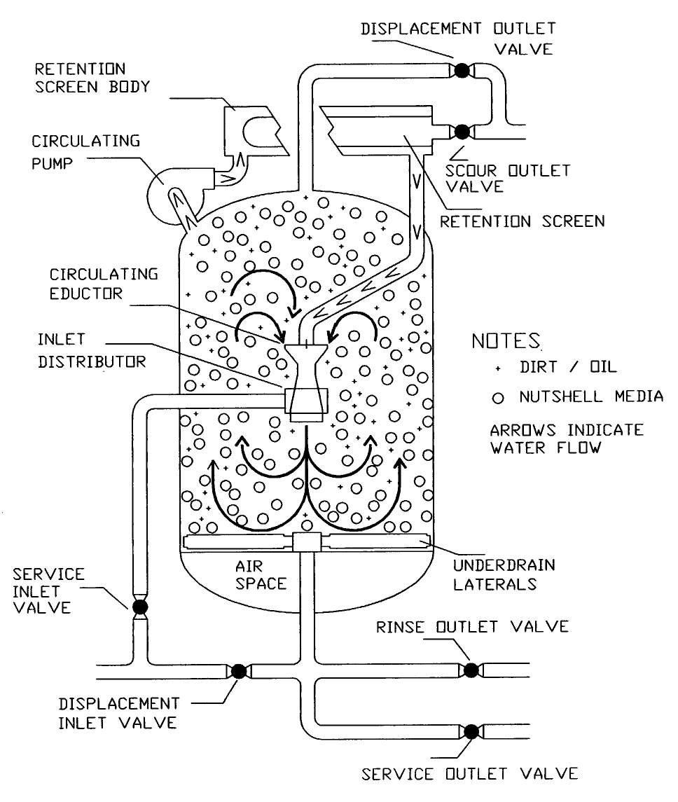

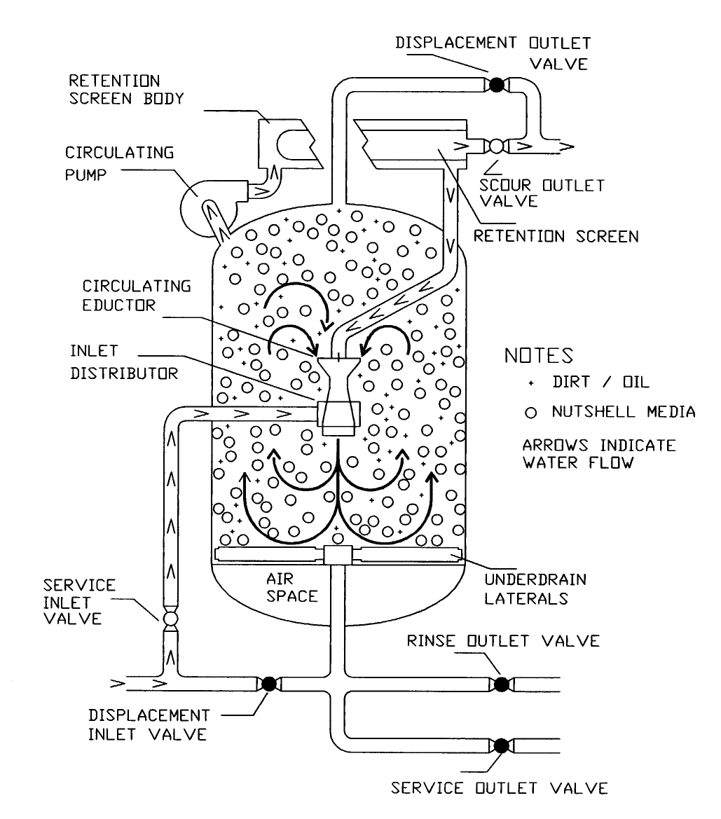

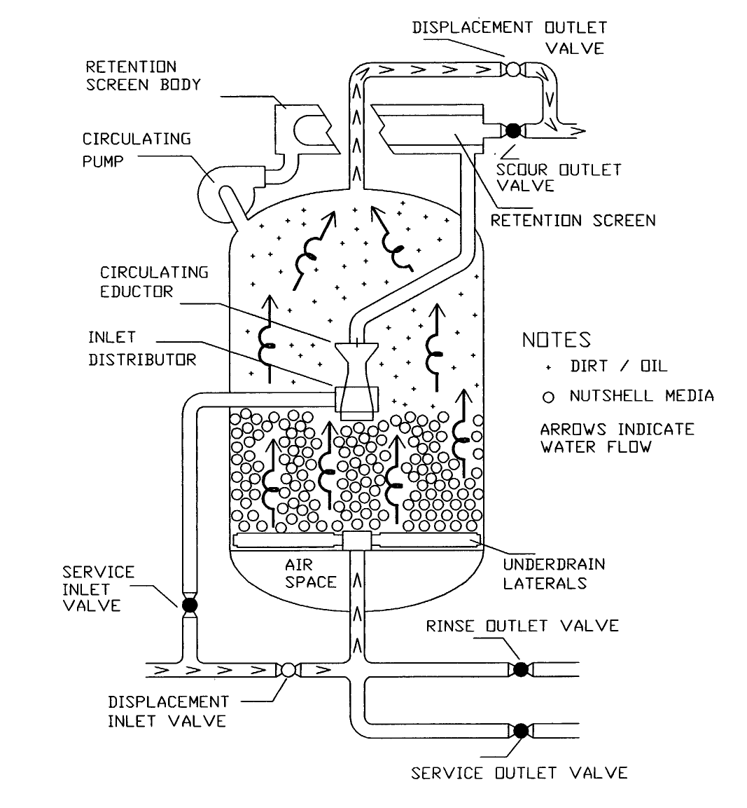

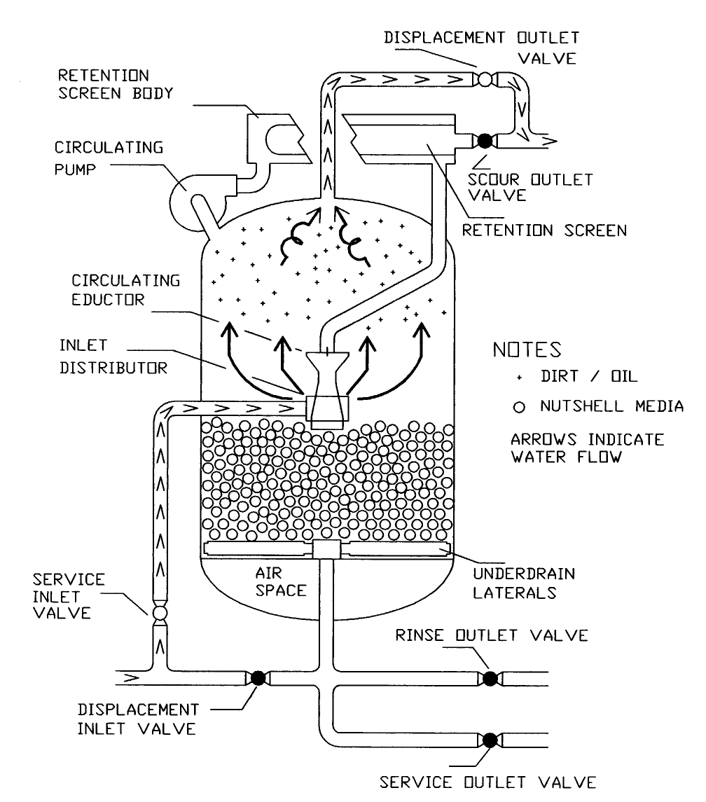

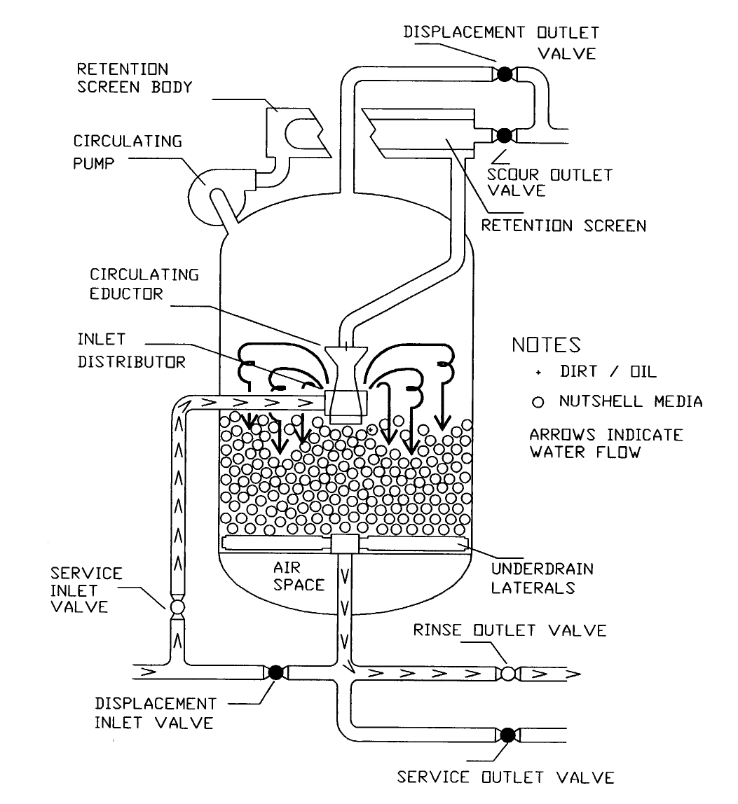

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The Eductor Circulated Nut Shell Media Water Filter pertains to the filtration of water, particularly water which is contaminated by hydrocarbons.

Nutshell media filters are usually used in the oil/petrochemical industries and to a lesser extent in metals processing with a few applications in other industries.

There are approximately five (5) different companies/persons in the world manufacturing a version of this type of filter.

Nut shell media filters generally consist of:

1. Vessel—usually a closed cylindrical tank

2. Media—Walnut or Pecan shell crushed to a 12-20 mesh. This type of media has a strong affinity for oils and other contaminants.

3. Under Drain System—usually wedge wire screen. The under drain system retains the media while allowing filtered water to exit the filter.

4. Scouring Mechanism—The scouring mechanism is used to scour the media to remove the oil/dirt during the media cleaning/regeneration cycle. Scouring mechanisms generally consist of either a high pressure/low volume pump, or an internal mixing device to stir the contents of the vessel.

5. Process Valves/Piping—The valves and piping are configured to control the flow and direction of water during the service and cleaning steps.

Typically the under drain system is placed at the bottom of the vessel and connected to a nozzle which goes through the bottom shell of the vessel. The nutshell media is placed in the vessel on top of the under drain. The media bed depth is usually about 35-50% of the vessel height.

During operation the nutshell filter operates like any other type of media filter. Water is pumped into the top of the vessel and flows down through the media where it passes through the under drain screens and then exits the filter. The filter media, ground nutshells, has a strong affinity for oil. The oil in the water is actually adsorbed onto the surface of the ground nutshells. The dirt particles in the water are blocked from traveling down through the media bed if the particles are bigger than the channels the water flows through as it travels downward through the media.

Because nutshell media filters are generally used in applications where the water contains oil, the media is generally heavily fouled with oil after a service cycle. Media Cleaning between service cycles is accomplished by scouring the media, either by running it through a centrifugal pump, or a by using a mechanical mixer to circulate it within the vessel. As the media particles rub against other media particles, the sides of the vessel, or the blades of the mixer, oil and other contaminants are scraped off of the media surface. After the media has been sufficiently cleansed, the filter is placed back in service

The scouring creates a slurry of extremely contaminated waste water, which must be washed out of the filter, and stored for further processing.

To date all of the systems use the same basic method/sequence to clean or regenerate the media once it has become loaded with contaminants. The cleaning/regeneration sequence usually involves the following steps:

A vent step to remove any trapped gases and floating oils from the top of the filter vessel.

A scouring step to agitate and clean the media. This is done either through a pump/nozzle system, or an internal mixer system.

Next, the discharge step removes the slurry from the vessel by adding cleaner water to the vessel and flushing out dirty water.

As the clean water is added to the vessel, the pump or mixer keeps the water circulating inside the filter. A media loss prevention screen, usually fabricated from wedge wire is used to keep the media from being washed out with the slurry. This step continues until approximately 75% (sometimes more) of the contaminants have been removed from the filter.

The next step is usually a settling step in which the pump or mixer is turned off and the media is allowed to settle back to the bottom of the filter.

The final step in the cleaning sequence is usually a rinsing step in which unfiltered water is added to the system to flush out any remaining contaminants which have been scoured off the media particles.

During the rinse step, the system operates as though in service, except the filtered effluent is stored for further treatment until the level of contaminants in it drops to acceptable levels. Once the effluent is acceptably pure, the system is then put back into service.

Most current nutshell media filters suffer from the following deficiencies related to the cleaning/regeneration of the nut shell media:

With prolonged use the media becomes so badly fouled that it can't be cleaned and must be discarded.

The cleaning/regenerating process does not clean the media well enough for the filter to produce the quality of water required. This is usually because so much dirt/oil remains in the filter after the media cleaning cycle that it leaches out during service degrading the quality of the water produced.

The cleaning/regeneration process produces a large amount of waste water as current nut shell media filters must be regenerated more often or for a longer period to clean the media well enough for the filter to produce the quality of water required.

Current nutshell filters also suffer from media attrition. Quite often the filters require long cleaning cycles to clean/regenerate the media. These long cycles mean that the media is being scoured more often, and for longer periods. This additional scouring tends to grind down the media requiring the replenishment of the media.

Current nutshell media filter designs also suffer from deficiencies other than those related to the cleaning/regeneration of the filter media.

Current nutshell media filters suffer from filter particles plugging their media loss prevention screens, leading to reduced water flow, or damage to the screens requiring their replacements.

Current nutshell media filters mount their media loss prevention screens in a manner which makes their maintenance or replacement difficult and time consuming.

### BRIEF SUMMARY OF THE INVENTION

This application is for a series of design features and a new media cleaning/regeneration cycle to address all of the problems listed previously, both in system performance and mechanical design.

The invention includes several mechanical designs as well as a new media cleaning/regeneration cycle.

Design Feature #1

The Eductor Circulated filter uses a Horizontal Media Retention Screen located on top of the vessel. This allows the use of a much larger screen than current filters have. In addition, the screen/piping is not susceptible to plugging from media settling when the pump is turned off. Finally, the screen can be removed/inspected by one person without removing any piping or the screen housing.

Design Feature #2

The Eductor Circulated filter uses a Balanced Flow Concentric Inlet Distributor placed just above the top of the nut shell media bed. The inlet distributor drastically reduces currents in the filter during the service run. This reduction of currents allows oil in the water to coalesce more readily forming small drops that float to the top of the filter thus reducing the amount of oil that the media bed must adsorb. The location of the distributor is also important for the new backwash cycle.

Design Feature #3

The Eductor Circulated filter includes a False Bottom located just below the header/lateral Underdrain System. This feature reduces the amount of water needed to clean the media, reduces the amount of water required to rinse the media, eliminates any possibility of Underdrain screen damage, and prevents the leaching of contaminants into the filtered water during filter service

Design Feature #4

The Eductor Circulated filter includes a Circulating Tank Eductor located inside the vessel. This eductor converts the high pressure/low volume discharge from the pump into a low pressure/high volume flow which circulates and scours the media more efficiently than rotating mixer blades or pumps.

Design Feature #5

The Eductor Circulated filter Circulating Pump is connected to the motor via a flexible coupling attached to a jackshaft with pillow block bearings and then via belts and sheaves. This motor mounting method allows a compact installation, without sideloading the pump shaft.

Design Feature #6

The Eductor Circulated filter utilizes a proprietary Plug Flow Displacement Media Cleaning Cycle. The media cleaning cycle has several variations. The standard cycle involves the following steps— Venting, Scouring, Plug Flow Displacement, and Rinsing.

The initial Venting step involves closing all valves, followed by opening the service inlet valve and the displacement valve on top of the vessel. Water flowing in through the service inlet purges the gas and floating oil trapped at the top of the vessel out through the displacement valve.

The second part of the Venting step involves closing the displacement valve on top of the vessel and opening the discharge valve on the retention screen body. This forces any oil and gas trapped in the retention screen body out of the system.

The Scouring step involves pumping the media/water slurry past the retention screen and through the eductor where it is discharged back into the vessel. The eductor converts the high pressure/low volume pump discharge into a low pressure/high volume flow. This high volume flow circulates the media, allowing the media particles to scour themselves as they collide in the vessel.

The Scouring step can be done with or without running additional water through the system. If the overall plant design does not require the continuous pumping of water to the filter system then the media retention screen can be eliminated from the installation. This step may then be undertaken without any open valves. If continuous flow is required then the service inlet valve and discharge valve on the retention screen body will be opened. The other valves will be closed.

The Plug Flow Displacement step is the next step in the Media Cleaning Cycle and has the following variations.

In all of the variations the pump is turned off.

If the unfiltered water is relatively uncontaminated, the backwash inlet and displacement valves on top of the vessel are opened until an amount of water equal to the volume of the vessel has flowed through the vessel.

If the unfiltered water is moderately contaminated this step is broken into two parts.

In the first part of the step unfiltered water enters through the backwash inlet valve on the bottom of the vessel, travels up through the media, and then discharges out the displacement valve on top of the vessel, pushing the extremely dirty suspension of water and contaminants ahead of it. After a volume of water equal to the volume of water in the filter below the inlet distributor has passed through the filter the second part of this step will start.

In the second part unfiltered water enters the vessel through the inlet distributor and travels up pushing the suspension of water and contaminants ahead of it. This step terminates after a volume of water equal to the volume of water in the vessel above the inlet distributor has passed through the vessel.

If the unfiltered water is very contaminated, the displacement step consists of opening the service inlet valve and the displacement valve on top of the filter. The incoming water pushes the extremely dirty solution of water and oil/dirt ahead of it and out of the filter.

When a volume of water equal to the amount of water in the vessel above the inlet distributor has passed through the vessel, this step will terminate. At this stage the cycle may repeat the scouring step and the displacement step (may repeat more than once) depending on how heavily fouled the media was at the start of the cleaning cycle.

The final step in the Media Cleaning Cycle is the Rinse step in which the service inlet valve and rinse outlet valves are opened, flushing unfiltered water through the media and out the discharge piping to remove any loose dir/oil that is in the outlet piping. The filter will then be placed back in service.

Depending on the particular filter installation one or more settling steps may be inserted between these basic steps to allow time for the valves to change positions before the next step is started.

### BRIEF DESCRIPTION OF THE SEVERAL VIEWS OF THE DRAWING

Drawing 1/14

This is a drawing of the general arrangement of the nut shell filter showing the typical arrangement of the agitating pump and the horizontal arrangement of the media retention screen housing

Drawing 2/14

This is a drawing of the general arrangement of a typical nut shell filter vessel showing the false bottom and header/laterals, the location of the inlet distributor, and the Circulating Tank Eductor.

Drawing 3/14

This drawing shows the fabrication details of a typical false bottom with box header and laterals.

Drawing 4/14

This drawing shows the fabrication details of a typical Concentric Inlet Distributor.

Drawing 5/14

This drawing shows the fabrication details of a typical Circulating Tank Eductor

Drawing 6/14

This drawing shows the connection details between the motor and circulating pump including the coupling, jackshaft, pillow block bearings, and belts/sheaves

Drawing 7/14

This drawing shows how filter media settles in the horizontal media retention screen body when the pump is shut off.

Drawing 8/14

This drawing shows how filter media settles in a vertical media retention screen body located outside the filter when the pump is shut off

Drawing 9/14

This drawing shows the typical flow path when the filter is in service

Drawing 10/14

This drawing shows the typical agitation step without wastewater discharge

Drawing 11/14

This drawing shows the typical agitation step both with wastewater discharge

Drawing 12/14

This drawing shows the lower displacement flow path.

Drawing 13/14

This drawing shows the upper displacement flow paths.

Drawing 14/14

This drawing shows the flow path of the rinse step

### DETAILED DESCRIPTION OF THE INVENTION

Design Feature #1.

Horizontal Media Retention Screen

Early nutshell filters had either an internal flat screen or a vertically oriented cylindrical shaped screen to retain the media during the cleaning cycle. The flat screens proved to be a total failure and this design has been dropped from further manufacture.

The vertical screens are placed either inside the vessel or outside the vessel.

Screens that are placed inside the vessel allow the nutshell media to fall away from the screen and settle to the bottom of the filter when the cleaning pump is turned off. In this way, no piping or screens can be plugged by media settling in them (see Drawings 7/14 and 8/14). However, screens that are placed inside the vessel require the vessel to be disassembled in case of maintenance/repair.

Vertical screens mounted on the outside of the filter vessels are prone to plugging if the power fails during the cleaning cycle. This is because the media settles from the vertical pipe and accumulates at the vertical to horizontal transition elbow. These types of filters need a flushing step to remove the nutshells from this area. Some of these types of filters do not incorporate flushing valves and may plug even after the cleaning cycle is complete.

Additionally, vertically mounted screens are limited in their length by that fact that the screen is usually placed between the agitating pump and the top or the side of the media bed (depending on discharge nozzle location). Lengthening the screen would usually require raising the overall height of the package either by increasing the length of the filter shell or by raising the pump mounts.

A horizontal screen and body by their very nature will not form a plug even if media settles in the body. This is because the media settles to the bottom of the body leaving a passageway for water through the top portion of the body (See drawing 7/14). The next time the pump is turned on the high velocity of the water immediately re-suspends the nutshells in a slurry that can be pumped through the piping.

The horizontal arrangement used in the Eductor Circulated filter allows the screen to be lengthened without increasing overall height. This screen/housing design is fabricated such that the screen can be removed without disassembling any piping or removing the screen housing. The screen can also be removed by one person without ropes, hoists, etc.

Furthermore, by placing the screen on top of the vessel the relevant piping can be done such that the screen is in either the pump suction line, or the pump discharge line. The most common arrangement is in the pump discharge line but by placing it in the pump suction line the size of the pump required can be further reduced. The reduction occurs because when the screen is placed in the discharge line the water that is drawn off (wastewater) is deducted from the pump output for the agitation calculation. All of the water goes through the pump but then the wastewater is discharged before it goes to the eductor.

For example, if that the pump pumps three gallons of water, one gallon of water is drawn off as wastewater and only two gallons remain to power the eductor. If the screen is before the pump then 1 gallon is drawn off through the screen but the pump still pumps three gallons. All three of these gallons are used to power the eductor.

Design Feature #2

Balanced Flow Concentric Inlet Distributor (See Drawing 4/14)

This device evenly distributes the incoming water flow, and reduces its' velocity so that it does not disturb the media, thereby allowing oil in the incoming water to coalesce and float to the top of the filter. The distributor also eliminates turbulence near the top of the filter so that the oil layer stays separated and does not remix with the water.

Current walnut shell filters typically have just a nozzle that dumped water into the filter in one large stream. Some filters used a “splash plate” to divert the large stream and send it in several directions. Other filters were designed with the inlet nozzle splitting into two streams through a “T” or two elbows. Neither design promotes oil droplet formation, and both designs create currents which disturb the media bed.

The location of the Balanced Flow Concentric Inlet Distributor is an integral part of the design of the Eductor Circulated filter. This design feature contributes to the superior service and cleaning cycles of the filter.

The Balanced Flow Concentric Inlet Distributor is located as far away as possible from the top of the filter vessel, just above the top of the media bed. This eliminates virtually all currents near the top of the vessel. The absence of currents at the top of the vessel allows oil droplets to float to the top of the vessel, where they form an oil layer. Other current filter designs suffer from turbulence, which mixes the oil and water layers, putting some of the oil back in solution.

The location of the Balanced Flow Concentric Inlet Distributor is also a critical in the upper plug flow displacement step of the cleaning cycle. In the plug flow step lightly contaminated unfiltered water flows through the Balanced Flow Concentric Inlet Distributor, displacing extremely dirty water in the vessel in an upward plug flow. By placing the Balanced Flow Concentric Inlet Distributor just above the top of the media it is possible to displace all of the extremely dirty water above the top of the media in a plug flow pattern, using a volume of water equal to the volume of the vessel itself.

The Balanced Flow Concentric Inlet Distributor consists of the following: An inlet pipe through the side shell of the filter delivers the water to a “T” in the center of the vessel. The “T” is oriented such that two of the open ends are facing vertically (one up and one down). The third opening faces the side of the filter shell. The inlet pipe is connected to the side opening of the “T”. A number of holes are drilled equally spaced around the top half of the “T”. A similar series of holes is drilled around the bottom half of the “T”. A plate is welded across the top opening of the “T” and a short piece of pipe is welded to the bottom half of the “T” and additional equally spaced holes are drilled around the circumference of this pipe. A formed cone is attached with a small space between the end of the short pipe piece and the inside of the cone.

Incoming water is distributed in two patterns. The first pattern is produced by the water exiting the “T” and short pipe piece via the many equally spaced holes around the circumference. The pattern is many equally spaced small streams flowing outward radially from the center like the spokes of a wheel. The second pattern is produced by the water that exits the bottom of the short pipe piece. This water hits the inside of the cone and reverses direction. It exits the top of cone in a cone shaped flow, upward and outward.

Design Feature #3

Filter Vessel False Bottom (See Drawing 3/14)

This patent seeks to cover the use of all false bottoms in nutshell filters. This would include filling the lower head with a solid media such as concrete as well as true false bottoms which are fabricated as part of the vessel.

In a nutshell filter all of the internal volume of the vessel has to be cleaned during the cleaning cycle to remove dirt/oil. This includes unused space below the Underdrain collection system. If there is space below the Underdrain which contains media this media must be cleaned, as it will contain contaminants even though it does not help to remove contaminants during the service run. Cleaning of this superfluous media requires additional water during the cleaning cycle. The False Bottom of the Eductor Circulated filter occupies this space, ensuring all the media in the vessel participates in removing contaminants, and less water is needed to remove contaminants from the vessel during the media cleaning cycle.

If a flat screen Underdrain is used there will be a large void space under the screen. Because contaminants get under the screen when the media is agitated during the cleaning cycle, this void space increases the amount of water needed for the media cleaning cycle. The contaminants have to be removed in both the cleaning and rinsing steps by flowing additional water through this space.

In addition, flat screens tend to flex between service and cleaning cycles, leading to metal fatigue and eventual breakage. Finally, flat screens are very hard to support and thus limited in the amount of delta pressure they can resist.

Header/laterals are much stronger than a flat screen across the lower head of the vessel. However, the unused space they create has been an impediment to their use in the past. Filter media which settles under the laterals cannot be fully cleaned. Contaminants trapped on these media particles will leach out, re-contaminating the filtered water, degrading the quality of the filtered water produced.

Solid fill false bottoms eliminate the space beneath the Underdrain, and are cheaper to produce than true false bottoms. However, because the fill material and the vessel head material are different, they expand at different rates in response to temperature changes. This results in the solid false bottom scraping off the internal coating of the lower vessel head, and leads to internal rusting and premature failure of the vessel.

The false bottom described in this application is composed of several concentric support rings placed in the lower vessel head. A plate (the false bottom) is then placed on these rings and welded to the lower head and the support rings through holes. When the vessel is complete, this false bottom will only be wet on the topside. The bottom side always remains dry.

The false bottom serves two purposes. First, it reduces the unused volume of the filter thus reducing the amount of water required for the cleaning cycle (total waste water volume is decreased). It also eliminates filter media settling beneath the laterals.

Current nutshell filter designers have two choices other than flat screens. A screen can be contoured to fit into the lower head (similar to stacking one bowl inside of another). This allows the use of higher delta pressures as the screen is much stronger, and reduces the amount of volume under the screen, resulting in less total wastewater generated during the media cleaning cycle. However, it also results in an uneven media bed. The bed is deeper in the center than around the edges, causing an uneven flow of water through the media bed.

The other option is to install laterals, which are stronger than a flat screen. If the laterals are installed horizontally this leaves a large volume of media underneath the laterals increasing, the volume of total wastewater produced during a cleaning cycle and also allowing dirt/oil to leach out during service thus reducing water quality.

If the laterals are installed angularly to reduce the volume of media beneath them the result is more media above the laterals in the center of the vessel than is above the laterals around the edges. This results in uneven flow through the media bed during service.

Design Feature #4

Circulating Tank Eductor (See Drawing 5/14)

Current nutshell filters rely on one of two methods to clean the nutshell media. One method involves sucking the media and water into a centrifugal pump where the pump impeller helps to scour the media before it is re-injected into the vessel through a fluidizing nozzle. The re-injected stream is used to stir up and ‘fluidize’ the bed, keeping it in a slurry form that can be sucked into the pump. As the media is scoured in the pump some of the dirty water is ejected through a screen that retains the media.

There are several drawbacks to this method. One is that a high pressure/low volume pump discharge stream is an inefficient way to circulate the contents of a vessel, thus requiring larger, more expensive pumps than would be needed solely to scour the media.

Another drawback is that these large pumps run much more fluid/media through them than is needed to only scour the media. Because the media is ground down each time it passes through the pump, this increased flow results in a high attrition rate for the media.

The other method to scour the media involves placing a large mixer in the vessel. The drawback is that while a mixer with its low pressure/high volume circulation is much more efficient at mixing/agitating the bed and keeping it in solution than a pump circulation system, it necessitates large moving parts being placed inside a pressure vessel, with all the maintenance difficulties that entails.

The design covered by this application uses a centrifugal pump and a large circulating eductor located in the center of the filter with the discharge end facing down. The circulating eductor converts the high pressure/low volume of the pump discharge into a focused high volume/low pressure flow to circulate the media.

This high volume/low pressure flow is much more efficient at circulating vessels contents than a high pressure/low volume pump discharge. As a result, the circulating eductor allows filter media to be circulated using a smaller pump for a shorter period of time.

The high volume flow allows media particles to scour themselves as they collide with each other within the vessel, as opposed to current pump circulated filters in which a large portion of the scouring occurs as a result of media particles striking the rotating pump impeller. The final result is that the media is thoroughly scoured within 5-6 minutes of pump operation, compared to 15-60 minutes (or more) for current pump circulated filters. This greatly reduces media attrition. Finally, the smaller pump consumes less electricity than current high-pressure/low volume pump circulated systems.

The circulating eductor design is superior to mixer only designs in that it circulates as well or better than a mixer, has approximately the same media attrition as a mixer, and scours the media better than a mixer alone.

In addition, unlike internal mixer designs, a filter which uses a circulating eductor to circulate filter media does not have any moving parts inside the vessel, simplifying maintenance. All moving parts are on the outside of the filter with easy access.

Design Feature #5

Flexible Coupling with Jackshaft and Pillow Block Bearings (See Drawing 6/14)

Current nutshell filters have the pumps/mixers either direct coupled (motor is coupled directly to the pump/mixer) or side loaded (motor is on the side of the pump/mixer and connected via belts and pulleys).

Although direct coupling is recommended by pump manufacturers, it results in a long piece of equipment (pump and motor mated end to end) and often this extra length exceeds what is available to mount the equipment due to overhead height restrictions.

Side loading the equipment translates into a smaller total package that can be mounted in tighter areas. However, neither ANSI (American National Standards Institute) nor API (American Petroleum Institute) specifications accept side loading of centrifugal pumps. This is because side loading puts a sideways strain on the pump/mixer shaft, and the pump/mixers are not designed for these additional stresses. Side loading a pump can cause the shaft bearings and seals to wear out prematurely.

This patent covers a design that connects a motor to a pump via pulleys, belts, pillow bearings, a jackshaft and a flexible coupling. The resulting arrangement is a compact side driven assembly that transmits only rotation forces to the pump shaft. The side pull on the pump shaft is entirely eliminated.

In this arrangement a flexible coupling attaches the pump shaft to a jackshaft (short independent shaft). The jackshaft is held in position via large pillow block bearings. On the other end of the jackshaft is a pulley for the belt drive to connect to the pulley on the motor. When the force of the belts is transmitted to the pulleys and down the jackshaft it is absorbed by the pillow block bearings. Any deflection of the jackshaft is compensated for by the flexible coupling. The other end of the flexible coupling has no deflection and the only forces applied to the pump shaft are strictly rotational forces, and not side loads.

With this arrangement the pump can meet the loading requirements of both ANSI and API pump specification. Until this design, filters that utilized the side loaded pumps/mixers had to take exception to any project specification stating that the pumps were to meet API or ANSI specifications.

Feature #6

Media Cleaning Cycle (See Drawing 9/14-14/14)

This cleaning cycle involves the addition of one or more “plug flow displacement” steps to the media cleaning process. The eductor circulated cleaning cycle removes more contaminants from the filter media while producing less total waste water, and reduces media attrition independent of the rate at which water flows through the filter vessel during the cleaning cycle.

A plug flow displacement is an upward slow flow of water that pushes the extremely dirty water ahead of it. The movement is slow enough that very little mixing of the unfiltered water and the dirty water occurs. This allows the heavily contaminated water produced during the cleaning cycle to be thoroughly purged using a single vessel volume of water.

There are three aspects of the cleaning process for nutshell media filters that set them apart from all other types of media filters.

First, nutshell filters are cleaned with unfiltered water. Most other types of media filters are backwashed with filtered water, or at least have a short step at the end of the backwash cycle which uses filtered water. This means that a filtered water storage tank and an additional pump are required to feed the filtered water to the media filter during backwash. The nutshell filters are cleaned entirely with unfiltered water and do not require any additional source of water, chemicals, or air for scouring.

Second, the flow to a nutshell filter does not have to be interrupted during the cleaning cycle. The filtered water outflow is interrupted during the cleaning cycle but a constant flow of water is always fed to the filter. This is important in some processes (oil production etc.) where the feed flow must remain constant and upstream surge tanks etc. are not available (offshore production platforms have limited space to install tanks etc.). The nutshell filters never need to interrupt upstream flow, and can be cleaned at the same flow rate (or even a lesser one) as the service flow rate.

Third, unlike filters using other media which usually must be backwashed at a flow rate that is much larger than the service rate, nutshell filters may be cleaned using any flow rate. However, although current nutshell filters can be cleaned at a flow rate that is lower than the service rate, the reduced flow rate requires longer cleaning time, which increases media attrition.

Current nutshell filters all have similar cleaning cycle regardless of whether they use pumps or mixers to agitate the media. The cleaning cycle involves an agitation/discharge step in which unfiltered water is fed into the filter while the media is being agitated. The incoming, moderately contaminated water forces out an equal amount of extremely contaminated water as the contents of the vessel are constantly mixed.

As this step progresses, the water being discharged has less and less dirt/oil in it. It is a diminishing returns process as it takes more and more water inflow to remove equal amounts of dirt and oil.

A simple equation to estimate how much dirt/oil is left by current media cleaning cycles after a certain amount of water has been fed to the vessel during a cleaning cycle is X=100(0.5)^{V}. X is the amount of dirt/oil remaining in the media expressed as a percentage of the amount of dirt/oil that was in the media at the start of the cleaning cycle. V is the number of vessel equivalent volumes, i.e. the amount of water that was fed to the filter divided by the entire volume of the filter including any unused areas (any part of the filter that holds water including areas under flat screens or in laterals etc.) This equation is a rough approximation, as it does not take into account the volume of the media or the fact that some of the oil/dirt sticks to media more than other oil/dirt particles.

Current nutshell filters produce approximately two vessel equivalents of waste water during the cleaning cycle, while removing approximately 75% of the dirt/oil in the media each cycle. This means the filter media begins every new service cycle with about 25% of its contaminant holding capacity already used.

The media attrition of current nutshell filters is directly correlated to the flow rate of the filters during the cleaning cycle. If the flow is increased, then the time required to put two vessel equivalent volumes into the filter decreases. Since the pump or mixer is running constantly during the cleaning step, a decrease in the cleaning step time results in a corresponding decrease in media attrition.

This is of particular concern when a filter is designed for a large peak flow (a large filter volume) but normally operates at a small flow, as is the case for refinery waste water run off. During a rain storm, the filter may receive a large flow rate from all of the cachements. However, during normal operation the only waste water it receives is from leaking pump seals etc. This low flow rate means that it can take a long time (an hour or more) to run the two vessel equivalent volumes through the filter. The result is a very high media attrition rate.

The Eductor Circulated cleaning cycle begins with an agitation step. During this step the unfiltered water is fed to the filter as it is in current nutshell filters. The circulating eductor sufficiently agitates the media to scour most of the contaminants off the media particles, and into solution within 2-3 minutes, unlike current nut shell filters which require longer scouring times. The contaminants do not settle quickly, and remain suspended in the water during the next step.

Next, the pump is turned off and unfiltered water is fed into the filter from the bottom. During this time the media settles to the bottom of the filter where the incoming unfiltered water is entering. The media therefore settles into the relatively clean incoming water as it pushes the extremely contaminated water up ahead of it in a plug flow displacement.

This flow pattern is quite similar to the backwashing of a sand filter except that it occurs at a much slower rate. In sand filters the backwash water is injected at a high rate to help expand and agitate the bed as well as push the dirt out of the filter. If the water flow rate is not high enough in a sand filter the bed will not be agitated and the dirt will not be removed. In this nutshell filter a slow flow rate is no problem

Because virtually all of the dirt/oil is flushed out of the vessel by the plug flow displacement, one vessel equivalent volume (plus the small amount fed during the 2-3 minute scour step) can remove almost 100% of the dirt in the media compared to the two vessel equivalent volumes of water required to remove 75% of the dirt/oil in the other nutshell filter designs. If needed, the cleaning cycle may feature a second agitation step followed by another displacement step. This second agitation/displacement cycle is a polishing step to remove any dirt that may have been trapped by the falling media in the first displacement step.

Since the eductor circulated filter has a false bottom, the vessel equivalent volume of this filter is less than the vessel equivalent volume of the other designs for a filter of equal outside dimensions. The reduced internal volume of the eductor circulated filter, and its' use of plug flow displacement to flush the heavily contaminated water created by the scouring of the media creates half the waste water current filters use to remove only 75% of the dirt contaminating their media.

Because the eductor circulated filter cleans nutshell media more thoroughly, run time between cleaning cycles is increased. The combination of less waste water produced per cleaning cycle, and increased time between cleaning cycles, results in a substantial reduction in waste water volume produced during a given period of operation.

There are three possible types of displacement cycles available with this particular filter design. A particular cycle is chosen based upon the level of contaminants in the unfiltered water, and the likely hood of the contaminants fouling an underdrain screen.

If the unfiltered water is relatively uncontaminated, the displacement cycle will consist of only one step. Water will enter the vessel through the underdrain, flow upward, and exit the top of the vessel.

If the water is moderately contaminated the displacement cycle will consist of two steps. In the first step water enters the vessel through the underdrain, flows upward, and exits the top of the vessel. After about 3 minutes the second step will begin. In this step the water will enter the vessel through the inlet flow distributor, flow upward and exit the top of the vessel. This is the most common mode of operation for this filter.

If the water is very contaminated and is likely to foul the underdrain screens the third type of cleaning cycle is chosen. This cycle consists of only one step. The water enters the vessel through the inlet distributor, flows upward, and exits the top of the vessel. In this step unfiltered water never flows through the underdrain screen so the chances of fouling are almost eliminated.

What I claim as my invention is the following:

1 For the horizontal mounting of a cylindrical media retention screen on a nutshell filtration system, either before or after the media scouring pump.

2 For the Balanced Flow Concentric Inlet Distributor located as close as possible to the top of the media bed, designed to equally distribute the incoming flow of water to a nutshell filter in a manner that promotes the coalescing of oil droplets, and enables plug flow displacement of the water above the media without running water up through the media.

3 For the use of a False Bottom (either fabricated as part of the vessel or added later such as concrete subfill) in a nutshell filter that utilizes laterals as the underdrain collection system.

4 For the use of a Circulating Tank Eductor in a nutshell filter to increase the circulation/agitation of the media bed. This covers mounting the eductor inside the vessel as well as externally with pipes that would provide the same result.

5 For the use of a Jackshaft and pillow block bearing used in conjunction with belts and sheaves to connect the drive motor to the scouring pump on a nutshell filter to reduce any side loading of the pump shaft, transmitting rotating forces to the shaft only, enabling the pump and motor to be mounted side by side to reduce space requirements and still meet API and ANSI requirements for loading diagrams and shaft deflection.

6 For the use of a plug flow displacement step or steps in the cleaning cycle of a nutshell media filter
